(19) United States
(12) Patent Application Publication
(10) Pub. No.: US 2005/0208224 A1
(43) Pub. Date: Sep. 22, 2005

(54) Method for applying an anti-corrosion coating to especially corrosion exposed parts in rock drill equipment

(76) Inventor: Goran Stenberg, Fagestra (SE)

Correspondence Address: YOUNG & THOMPSON, 745 SOUTH 23RD STREET, 2ND FLOOR, ARLINGTON, VA, 22202, US

(21) Appl. No.: 10/508,053

(22) PCT Filed: Mar. 14, 2003
(86) PCT No.: PCT/SE03/00432

§ 371 Date: May 13, 2005

(30) Foreign Application Priority Data
Mar. 20, 2002 (SE) 0200874-6

(51) Int. Cl. B05D 7/00; B05D 1/18

(52) U.S. Cl. 427/402; 427/430.1; 427/421.1

(57) ABSTRACT

The present invention relates to a method of protecting corrosion vulnerable parts of rock drilling equipment in particular against corrosion, particularly a shank adapter, wherein the adapter is coated by zinc phosphatization, zinc manganese phosphatization or manganese phosphatization followed by an oiling or waxing process.

The present invention relates to a method of protecting against corrosion those parts of rock drilling equipment that are particularly vulnerable to corrosion, particularly in respect to surface coating a torsion force and percussion force transferring shank adapter.

Rock drilling involves the use of drilling machines from which rotary forces, bit feed forces and impact energy are transmitted to a drilling tool, normally through an intermediate coupling of a string of splicing rods. Flushing medium, which may be water or air, is delivered to the region in which the drilling tool is situated through a hole or bore that extends longitudinally through the rods, with the intention of cooling the tool and also with the intention of removing drill cuttings from the drill hole. The rotary forces, drill feed forces and impact or percussion energy are transferred from the drilling machine to the rods/drilling tool by means of a so-called shank adapter. The greater part of the shank adapter is fitted within the drilling machine, from which a connecting end of the adapter protrudes for connection with the splicing rods/drilling tool. The shank adapter also includes a longitudinally extending hole that is open at said connection end for the transfer of flushing medium from the shank adapter to the splicing rods/drilling tool. The longitudinally extending hole in the shank adapter terminates in that part of the adapter which is located within the drilling machine and is connected to a flushing medium opening that is angled relative to said longitudinally extending hole. Alternatively, the shank adapter may include a through-passing flushing opening. The flushing opening communicates with a space in the drilling machine, from which flushing medium passed to the drilling machine can be led into the adapter through the flushing opening and from there through the longitudinally extending hole down to the splicing rods/drilling tool.

The aforesaid shank adapter is significantly affected when drilling in corrosive environments, or when corrosive water is used as the flushing medium, particularly in the region of the transverse flushing opening. For example, certain corrosive environments result in serious corrosion attack precisely in the region of the transverse flushing opening, therewith sometimes greatly reducing the useful life of the adapter.

With the intention of putting to rights this reduction in the useful life span of the adapter, attempts have been made to coat the passageway in the adapter with an anti-corrosive agent, although this has proved to be an expensive solution or has resulted in sealing problems. Among other things, trials have been made with the chromium plating, nickel plating and varnishing of shank adapters.

Accordingly, it is an object of the present invention to provide a novel method of protecting against corrosion those parts of rock drilling equipment that are particularly vulnerable to corrosion, such as to avoid the aforesaid problems and therewith increase the useful life span of such vulnerable parts.

This object is achieved with an inventive method in which the corrosion-vulnerable parts are coated by zinc phosphatization, zinc-manganese phosphatization, followed by an oiling or waxing process.

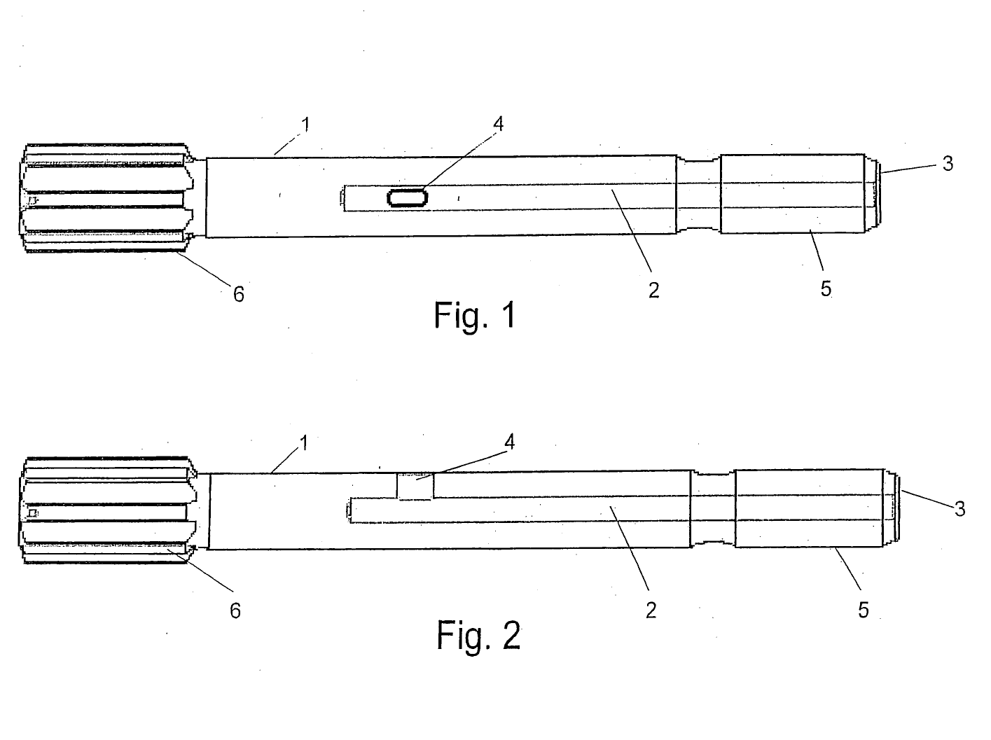

The invention will now be described in more detail with reference to a non-limiting embodiment thereof and also with reference to the accompanying drawings, in which FIG. 1 is a side view of one example of a shank adapter, and FIG. 2 is a corresponding view of the adapter shown in FIG. 1 with the adapter turned through 90° around its longitudinal axis.

The shank adapter shown in FIG. 1 is designed for use in a drilling machine for the purpose of transferring rotational forces, tool feeding forces, and percussion or impact energy from the drilling machine to a drilling tool through the medium of splicing rods. The adapter includes an elongate, essentially cylindrical body 1, which is suitably comprised of casehardened steel. Extending centrally through a part or through the whole of the elongate body is a hole or bore 2 which opens out at that end 3 of the body 1 at which a splicing rod/drilling tool (not shown) is fastened. A flushing medium opening 4 extends at right angles to the central bore 2 and opens out at the surface of the adapter 1. The end 3 of the body intended to receive the drilling tool has a part 5 which is conveniently provided with fastener means for connection of a splicing rod/drilling tool. This end part 5 is essentially the only part of the adapter that extends beyond the drilling machine. The other end of the adapter includes a drive 6 that has adapter-rotating splines, and also an end that can receive and forward impact forces. The adapter has smooth cylindrical surfaces around the mouth of the flushing opening 4 opening out into the cylindrical surface of said adapter, wherewith seals in the drilling machine sealingly abut said surfaces so that flushing medium fed into a chamber surrounding said adapter can be forwarded through the opening 4 and the longitudinally extending central bore 2 down to the vicinity of the drilling tool.

It has been found that it is precisely the area around the opening 4 that has been most subjected to corrosion when the drilling machine is used at sites on which the flushing medium, the water, is highly corrosive, or when water is left in the machine over stoppages of comparatively long duration.

A considerable improvement to corrosion resistance can be achieved by coating the corrosion vulnerable parts by zinc phosphatization, zinc manganese phosphatization or manganese phosphatization, followed by an oiling or waxing process. This phosphatization can be effected both internally in the adapter openings, i.e. in the central longitudinally extending bore 2 and in the flushing opening 4, and also on the external cylindrical surface of said adapter.

The aforesaid coatings will preferably have a thickness of at most 30 μm, which corresponds to about 50 g/m². The thickness most preferred, however, is 10-30 μm, which corresponds to about 10-50 g/m².

The phosphate layer can be applied to the adapter, by dipping said adapter into a solution containing chiefly phosphoric acid and zinc and/or manganese ions. Alternatively, a solution of this nature may be sprayed onto the adapter. Subsequent to having applied the phosphate layer to the adapter, the phosphate layer is oiled or waxed, wherewith the porous phosphate layer binds thereto relatively large quantities of oil or wax.

The inventive method in which corrosion vulnerable parts of the shank adapter are protected against corrosion by phosphatization and subsequent oiling or waxing of said parts is effective in extending the useful life of said adapters many times over, at low cost, when using said adapters in the aforedescribed corrosive environment.

Although the invention has been described with reference to protecting shank adapters against corrosion, it will be understood that the invention can also be applied in respect of other parts of drill equipment.

1. A method of protecting shank adapters against corrosion, charaterised in that the corrosion vulnerable parts of said adapters are coated by zinc phosphatization, zinc manganese phosphatization or manganese phosphatization, followed by oiling or waxing said parts.

2. A method according to claim 1, characterised by coating said parts by dipping the adapter in a solution that contains phosphoric acid and zinc ions, zinc manganese ions or manganese ions.

3. A method according to claim 1, characterised by spraying the shank adapter with a solution that contains phosphoric acid and zinc ions, zinc manganese ions or manganese ions.

4. A method according to claim 1, characterised by applying the phosphate coating to a thickness of up to 30 μm.

5. A method according to claim 1, characterised by applying said coating to a thickness of 10-30 μm.

6. A method according to claim 2, characterised by applying said coating to a thickness of 10-30 μm.

7. A method according to claim 3, characterised by applying said coating to a thickness of 10-30 μm.

8. A method according to claim 4, characterised by applying said coating to a thickness of 10-30 μm.
